(19) United States
(12) Patent Application Publication
(10) Pub. No.: US 2023/0130656 A1
(43) Pub. Date: Apr. 27, 2023

(54) System and platform for enabling personal health data ownership

(71) Applicants: Jun Beom Park, Mukilteo, WA (US); Vinay Manjunath Pai, Potomac, MD (US); Dhruv Bhandarkar Pai, Potomac, MD (US); John Paul Metzcar, Bloomington, IN (US)

(72) Inventors: Jun Beom Park, Mukilteo, WA (US); Vinay Manjunath Pai, Potomac, MD (US); Dhruv Bhandarkar Pai, Potomac, MD (US); John Paul Metzcar, Bloomington, IN (US)

(21) Appl. No.: 17/975,246

(22) Filed: Oct. 27, 2022

Related U.S. Application Data
(60) Provisional application No. 63/272,672, filed on Oct. 27, 2021.

(51) Int. Cl. G06F 21/62

(52) U.S. Cl. CPC G06F 21/6245; G06F 2221/2141; G06F 2221/2113; G06F 2221/2115

(57) ABSTRACT

A system is disclosed for a platform that enables the biological owner of health data to manage and control access to their health data. In an embodiment, biological owners can take possession of their own health data. They control the level of access to their own health data by third parties through the use of data blurring to fit within specific data ranges. They also control access to their data through data encryption. In another embodiment, the biological owner of the health data can provide access to their health data to third parties through an auction system. Such access would be provided based on price, time duration of access, or quality of data, as determined by the biological owner of the health data. Additionally, such access could be provided by the system managing the health data access for the biological owner of the health data.

### BACKGROUND

Field of the Invention: A system is disclosed for a platform that enables the biological owner of health data to manage and control access to their health data.

### DESCRIPTION OF THE RELATED ART

It is hard for individuals to get access to clear descriptions of diagnosis and/or treatment options for their health conditions. It can also be hard to find and enroll in clinical trials that are applicable to health conditions that they may suffer from. Additionally, it can be difficult to connect primary care doctors, who are taking care of the patients, with the state-of-the-art in medical diagnoses, treatment, and disease management, which may be limited in availability and access to within the large health care centers only.

Consider the case of patients with rare diseases, such as multiple endocrine neoplasia, von Hipple Landau, etc. These patients face a lack of definitive guidelines for treatment and management, let alone early recognition and diagnosis, and lack of easy access to effective clinical trials. Additionally, since the diseases are rare, the patients are neglected due to the small population affected by the disease, corresponding low profitability for medical companies, and the lack of adequate funding for research in treating or managing their rare disease.

Such patients also face challenges of lack of familiarity in the healthcare provider community with their disease management, as well as prolonged and drawn-out referral process to regional or national experts within quaternary health care centers, and identification and enrollment in appropriate clinical trials. For diseases that are heritable conditions, the patients may be uncomfortable voicing their concerns or participating in advocacy groups due to the fear of discrimination and/or other stigma that can come with suffering from a devastating and heritable genetic condition.

Notable shortcomings of the prior art are as follows: First, the lack of portability of one's own health data to some place other than the place of origination, usually the healthcare system in which the data were obtained (blood draw, radiographic imaging). If one was to transfer one's data from one hospital to another, either mailing, faxing, or physical CDs are involved. Second, the limited visibility and access to these original health data by tertiary or quaternary experts. If a leading expert in a rare disease works 3 states away, it will involve an initial referral process, brief review of transferred data, and then many more repeats of health data acquisition. Third, the inability of clinical trial investigators to identify and enroll enough trial participants from within the rare disease community. The investigators rely on limited referrals to become aware of existence for such rare disease patients sprinkled around each state. Being able to proactively identify rare disease patients besides relying on referrals may improve trial enrollment and statistical robustness of such trials. The current practice relies on only enrolling patients from within the pre-existing patients one has seen through a referral previously. Fourth, the limited control in understanding the biological owner's health data usage (when, where and how by whom). Once biological health data are imported within the health system, data can be used in any chart-biopsy or retroactive database-driven research without the biological owner receiving the alerts. Fifth, the ability to congregate with other patients of the same bodily malaise in a protected manner. Rare disease patients are sparse in numbers, and farther apart from one another than other common conditions with limited advocacy, attention and congregation. Current practices allow gathering of such patients in online communities as long as one self-claims to be suffering from the disease of interest. Oftentimes without privacy protection, protection from commercial motives by third parties, and without expert moderation, members within such communities are hurt with misinformation and interpersonal conflicts.

### BRIEF SUMMARY

A system is disclosed for a platform that enables health data owners to take possession of their data, and control the level of access to their data by third parties through the use of data blurring and data encryption. A system is disclosed for a platform that enables health data owner-initiated enablement of the health data owner to use an auction approach to develop a health data owner-controlled paid time-limited or data-blurring-limited access to the health data owner's data.

Further embodiments, features, and advantages of the invention, as well as the structure and operation of the various embodiments, are described in detail below with reference to accompanying drawings.

### BRIEF DESCRIPTION OF THE DRAWINGS

FIG. 1: Imported patient laboratory values with their matching reference range

FIG. 2: Binarization of numeric laboratory values into predetermined-clinically significant ranges with respect to known reference range

FIG. 3: Decoupling multiple laboratory parameters from a single patient to an individual, stand-alone laboratory values with binary values.

FIG. 4: Corresponding laboratory data from multiple patients can be mixed and matched for further apples-to-apples data processing and analysis.

FIG. 5: Patient-initiated importation of laboratory data

FIG. 6: Patient-initiated, OCR-assisted digitalization of laboratory data

FIG. 7: An overview of the internal data processing steps taken for blurring the data for an individual person.

FIG. 8: Four major entities involved in the software-based platform proposed in this application (“Pluri”).

FIG. 9: Overview of the initial enrollment process that a patient is expected to undertake when signing up for Pluri for the first time.

FIG. 10: Overview of the initial enrollment process that a subject matter expert, specialist, or physician are expected to undertake when signing up for Pluri for the first time.

FIG. 11: Overview of the initial enrollment process that clinical researchers or general researchers are expected to undertake when signing up for Pluri for the first time.

FIG. 12: Overview of how the Pluri system will recognize unique identifiers and their pairings (interactions) as a set of unique security tokens.

FIG. 13: Aggregate overview of unique identifiers and their interplay that enhances continued communication between already-established parties, and secure transaction of ideas and private health information.

FIG. 14: Overview of how patients can auction access to their data.

FIG. 15: Overview of patients deciding which portions of their data will be made available for Pluri

FIG. 16: Overview of patient-controlled access to the data on the patient's smartphone or local device.

FIG. 17: Overview of unique token identifiers connecting each patient to the Pluri platform.

FIG. 18: Overview of multiple tokens for physicians, researchers, or clinical trial investigators to allow time-limited access to fixed dataset.

FIG. 19: Overview of tokens building up a dataset by bundling multiple patients data.

FIG. 20: Overview of how physicians, researchers, or clinical trial investigators can build a customized search for specific type/quantity of data or specific number and types of subjects, and indicate how much they are willing to pay for how many time units.

### DETAILED DESCRIPTION

### Definitions

Health data: a collection of biological data obtained, observed, and originating from study of one's human body. These include bodily tissue, fluid, structural setup, numerical numbers obtained from the body.

Medical data: a subset of health data that pertains to a specific disease being discussed. It may be confined to a single diseased organ, collection of abnormalities commonly seen in a disease syndrome. These are subset of health data that can be utilized by healthcare providers to diagnose a diseased state based on abnormalities seen, or rule-out a condition based on lack of abnormalities.

Patient data: Clinically-relevant data informing about the health or medical condition of the patient. This can include, but is not limited to, laboratory values, images from imaging devices (such as X-ray, Computed Tomography (CT), Magnetic Resonance Imaging (MRI), Positron Emission Tomography (PET), ultrasound (US), Optical Coherence Tomography (OCT), digital pathology, virtual colonoscopy, etc.), data from smart devices and wearables used by patients, biometric data, patient diaries, etc.

Personal health data: An individual human being's health and medical data.

Pluri: The representative name of the software-based platform which is the intent of this patent application.

Biological owner of health data: An individual human being whose own personal health data is being considered, also known as data-owner.

Data Blurring: A process of minimal revealment of health data information, where the real value of any health data point is hidden and only the existence or absence of this data point within a predefined data range is confirmed. Within this disclosure, the terms “masking”, “binarization”, “silhouetting”, or “binning”, should be considered interchangeably with, and as parts of, data blurring as defined here.

Data Range: A predefined set of limits within which data provided by biological owners of health data will be segregated. This predefinition will be done using either existing medically defined limits, or by limits defined by the biological owner of the health data.

Third Parties: Persons or organizations who are not the biological owner of the health data, and with whom the biological owner of the health data can share their health data. Third parties are also known as data-utilizers.

Auction: A process of a data-owner selling limited access to their health data, to third parties. Such a process would sell access based on price (price bid by the third parties), time (time of access to data by third parties), data quality (quality of data, as determined by data blurring), or various combinations of these criteria. This process would be controlled either by the data-owner, or as assigned by the data-owner, by the system managing the auction process.

### DESCRIPTION

The software-based platform proposed in this application (henceforth referred to as the “Pluri” platform) is an invention to address these concerns, in order to facilitate rare disease and general patients to overcome such challenges in very unique ways: patient-centered, physician-coupled and guided, and algorithmically-driven information exchange between patients, their care team, and the clinical research teams.

For example, the current process of clinical trial enrollment primarily consists of two distinct approaches: a). The patient is guided by their specialist or primary care physician who, upon shared decision-making with the patient, searches for open clinical trials on sites on the internet (e.g. clinicaltrials.gov) and reaches out to the recruiters during an enrollment period, or b). The clinical trial investigators reach out to a subset of patients who have been referred or seen by them in the past, by parsing through their existing patient roster, in order to determine the select few that might meet inclusion criteria for a clinical trial. While the former process relies on the patient and the physician pair to correctly identify potentially appropriate trial, and a luck-of-the draw for such trials to be actively enrolling patients at the time of discovery by the patient, the latter process is limited and inherently biased (“selection bias”) as the trial will never have more than the number of patients previously seen by the researcher, which may potentially fail to capture greater number of study subjects (who had not been in the particular facility or the researcher's database).

The software-based platform proposed in this application is an invention that addresses this concern. In the proposed application, the patient and the clinician pair are stored in the platform's internal database, and the clinical researchers are also having accounts on the platform. The medical history information is provided by the patient on an as-needed basis (and certified by their physician). The clinical researcher provides to the platform the various criteria that they are looking for in the patient population they intend to study. The platform's algorithm then matches the patients with the most matches to the listed criteria, contacts the patients and asks them if they are interested in having their name put forward for the clinical trial. Upon consent from the patient, the patient's limited information (as decided by the patient) is provided to the clinical trial researcher. Additionally, the patients can also decide which of their clinical team members are added to the sign-up/enrollment process. The enrollment decision is then made by the combination of the patient-their clinical team-and the clinical trial researchers. This approach improves upon current processes by reducing both the luck-of-the-draw and the potential biases that are present. Since both the patients and the clinical trials teams are on the same platform, the selection bias is somewhat minimized (obviously, the patients who are not on the platform are still going to be missed from the selection pool), and since the patients and their physicians are seeing all the clinical trials that align for their needs as they show up, and are being matched by the platform algorithmically, the luck-of-the-draw is now eliminated.

Patients want control over their data and medical data privacy is an important aspect of this control. When patients are being enrolled in clinical trials or when their data is being used for medical research, current healthcare solutions do not provide patients the ability to control the level of data sharing that can be done: they cannot control the level of detail of sharing, they cannot control the type of data that can be shared, and they have limited control over who gets to see which portion of their data.

The software-based platform proposed in this application improves upon current processes by introducing the ability of the patients to control the level of data sharing that can be done, to whom it can be shared, which components of the data can be shared and till what duration, and the resolution of the pertinent data that is shared.

For example, the current process of health-related data sharing for patients is usually all-or-nothing as far as data access when patients release their data. When a patient signs an authorization to release medical records, all their medical records are released to the requesting party, with rare exceptions pertaining to mental health records and transmittable disease states.

The software-based platform proposed in this application improves upon this current process by allowing the patient to select which portions of their data are shared and at what level of resolution. For example, if their TSH (thyroid stimulating hormone) level is 500 mIU/L (reference range: 0.5-4.5 mIU/L), then the patient can control whether the information that is shared with the requesting party is the exact value, the value within a certain range, or just that the value exists. Thus, they could share that the value is 500 mIU/L, or that it is between 100-1000 mIU/L (or a range more relevant to the patient/requestor), or that the laboratory variable is being tracked. This example is just a view into how the patient can control the level of blurring of their data as shown to a data requestor; any one skilled in the art would realize that the blurring can be customized as per the patient's need. By this approach, the software-based platform proposed in this application improves upon current patient data sharing processes by allowing the patient to control access to their data.

The software-based platform proposed in this application improves upon current processes by introducing the ability of the patients to own their data and get revenue for their data. Current processes have the data owned by the hospital systems or companies who buy the health care data from hospitals, and do not allow a voice for the patients. The proposed application allows the patient to sell their own data through the auction marketplace of the software-based platform proposed in this application; they can decide the level of blurring (resolution) in the data they want to sell, they can sell their data in a longitudinal basis (i.e. selling particular laboratory value that may change over time), they can sell as a bundled package with other similar patients, etc. Any one skilled in the art would realize that the patient can customize the carve out of their data in approaches that allow the patient to increase the value of their data. Besides giving ownership of patient data back to the patients, this platform also incentivizes patients to get regular medical check-ups (as these act as individual data points) and increase the quality of healthcare. The system places emphasis on aspects of personal clinical data that often goes under-utilized: (1) it costs each patient their time, money, and physical pain to obtain such clinical data (such as laboratory values, X-ray/CT/MRI/echo images, data from smart devices worn by the patients), thus inherently assigning quasi-monetary value to these numbers, (2) such values can be used multiple times by multiple parties, with usages going beyond benefiting the patients themselves (i.e. fellow patients of similar disease state, or researchers), (3) being able to store, capture, and trend historical clinical values that well-predates one's enrollment in a clinical trial, outside of the trial setting, thus potentially providing insights to early stages of disease manifestation from a larger population database.

Various embodiments of the software-based platform are presented below:

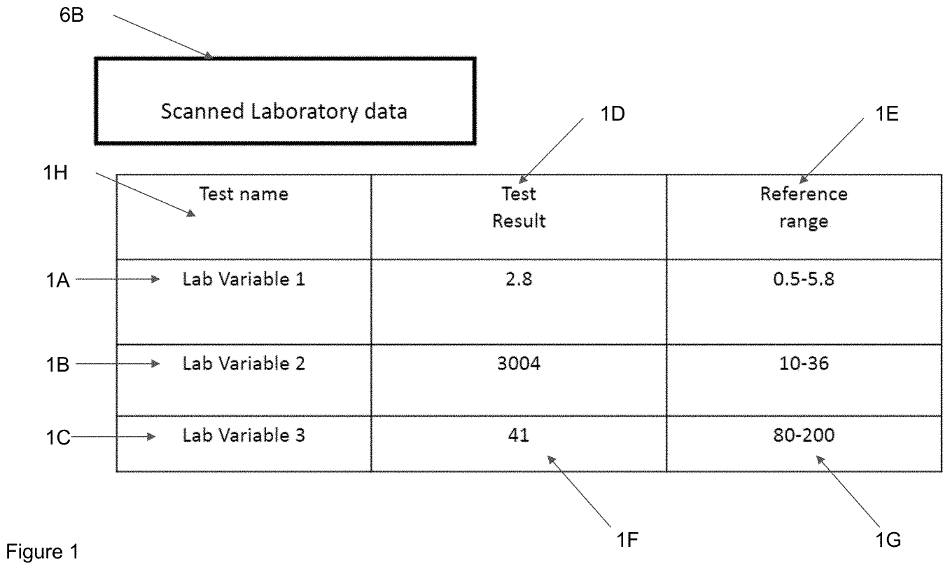

An embodiment of a typical set of scanned laboratory values 6B for a patient is shown in FIG. 1. This embodiment set contains information regarding test name 1H, which consists of 3 unique lab variables 1 through 3, 1A-1B-1C. For each corresponding lab variable, there is a column for test results 1D, with corresponding values 1F, and there is a column for the reference range 1E, with corresponding range values 1G.

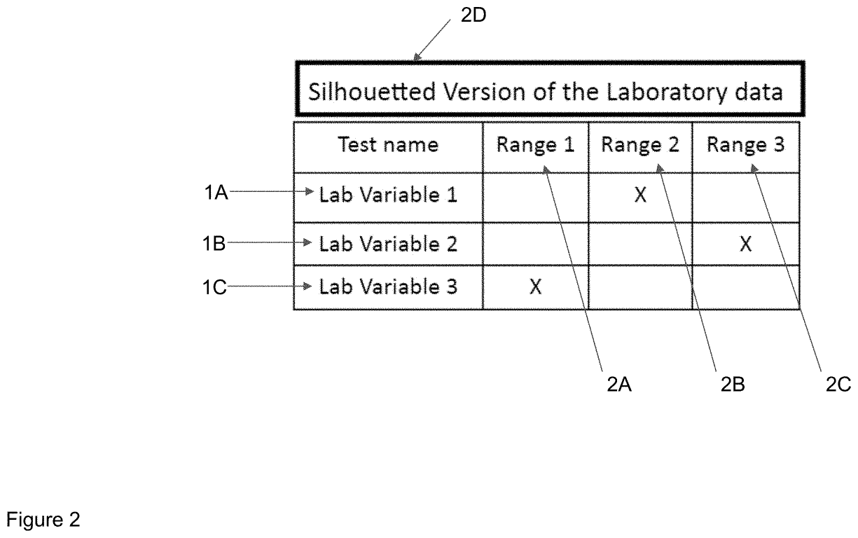

Once the original information for each lab values are imported, these undergo processing of numeric laboratory values into pre-determined clinically significant ranges with respect to known reference range 1E as shown in FIG. 2. The end product is called the Silhouetted version 2D of the laboratory data. Continued from the prior example, the 3 unique lab variables 1A, 1B, 1C, will each have corresponding values 1F. However, once having undergone this silhouetting process, such corresponding values are hidden by being placed into pre-determined bins 2A, 2B, and 2C with respect to their reference ranges. One embodiment of such binning could be high, normal, or low ranges. The purpose of binarization, silhouetting, or binning is to convert numeric values of each laboratory values to self-contain their clinical interpretation (e.g. is this high, normal, or low value?) as they have been processed against their reference ranges already.

In doing so, this allows the system to eliminate having to save the corresponding reference range, and having to crossmatch laboratory values to the reference range everytime the value is summoned and utilized. Also, different hospital systems and their respective laboratory facilities will have varying reference values established. Thus the current practice does not allow direct comparison of absolute laboratory values (numbers) side by side from different hospitals. Through the process shown in FIG. 2, the system aims to conjoin the clinical meaning, and allow comparability by reducing the regional or facility-based differences in the reference range. As such, this embodiment does not constrain the binning to just 3 bins, but enough bins as needed to clarify clinical meaning and relative clinical significance (with respect to general population, or with respect to 95% confidence interval, which is how a typical reference range is established)

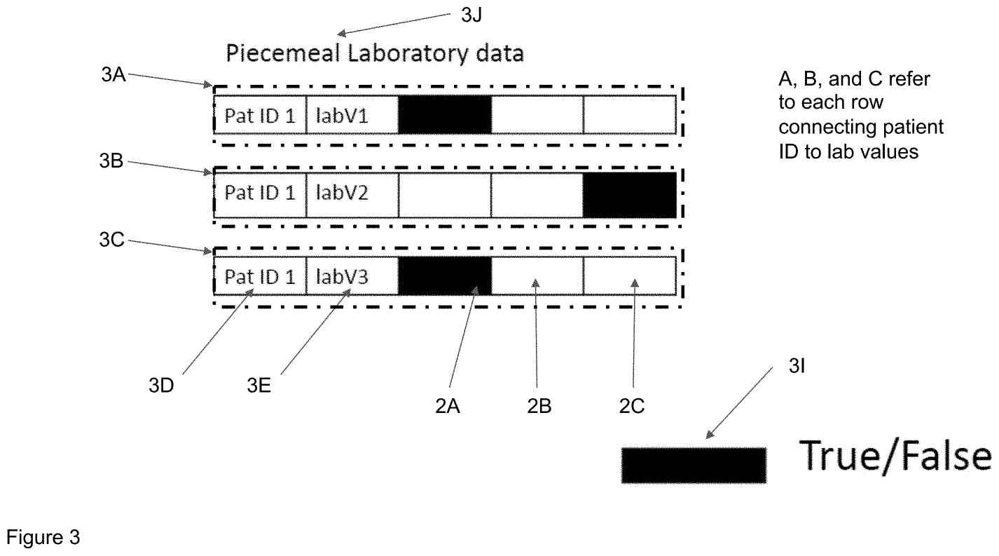

Once each laboratory values are silhouetted by being binarized (3I), these will undergo steps shown in FIG. 3, decoupling of multiple laboratory parameters from a single patient to an individual, stand-alone laboratory values with binary values. In this piecemeal laboratory data set (3J), the imported data set are further divided up so that various laboratory values (3E) that originated from a single patient (3D) can be utilized independent of other related or unrelated laboratory values 3A, 3B, 3C from the same patient. Approximate range at which the original laboratory values falls into with respect to the reference range (1E), will still be preserved as 2A, 2B, and 2C (range 1, range 2, range 3). This process delineated in FIG. 3 allows one or more laboratory values from a single patient to be compared to those of other patients, independent of other less relevant laboratory values obtained from the same patient. For example, if patient A's blood draw includes laboratory values for thyroid, liver, and kidney, this process allows the system to only utilize the thyroid lab values (while preserving its patient identifier, range of value) so that it can be compared to thyroid lab values from patient B.

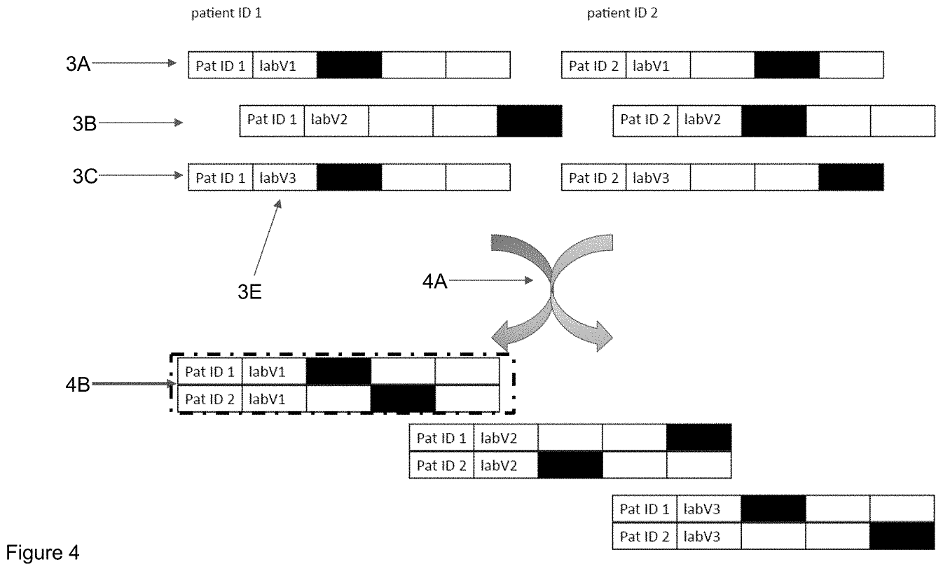

Direct comparison of corresponding laboratory values of interest between the two patients is demonstrated in FIG. 4. As previously discussed in FIG. 3, Patient A's thyroid, liver, and kidney values are separated into independent data set (3A, 3B, 3C), and through the matching process 4A, is able to be conjoined or brought side-by-side 4B with corresponding laboratory values from patient B which then allows direct comparison between values from patient A and patient B.

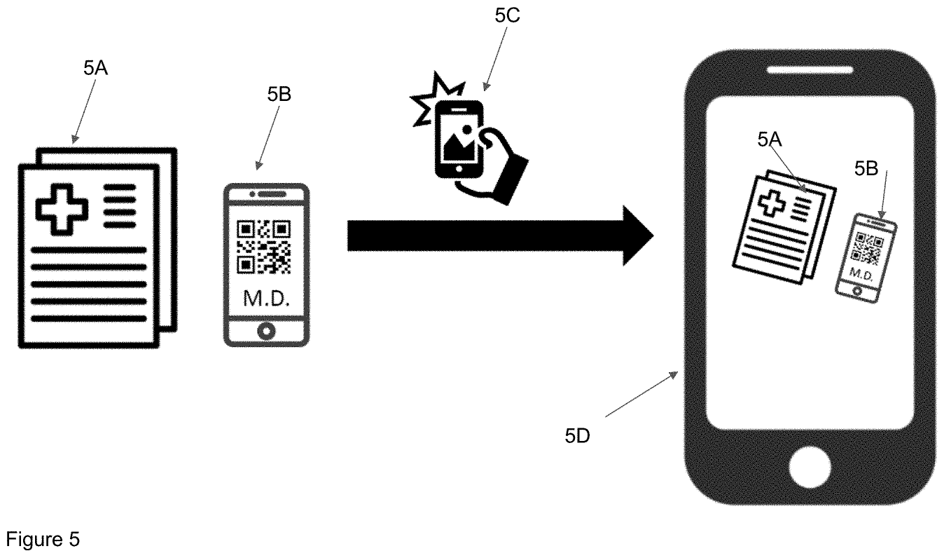

A simple overview of the patient-to-Pluri data importation process is delineated in FIG. 5. The patient's original laboratory value in a printed form 5A is placed side-by-side with a device 5B that displays a unique physician-identifying token (a QR code in this embodiment) signifying that 5A's validity and integrity have been vetted by the patient's physician who is assisting this importation process. Then the patient initiates the digitization process 5C utilizing one's personal device which then will capture both 5A and 5B in the same visual field as shown in 5D. This completes the initial importation process. Through this process, Pluri aims to achieve multiple things: (1) by optically importing one's data, Pluri is able to overcome interoperability issue, such as having to adjust and communicate with various electronic health records/electronic medical records (EHR/EMR) system, (2) by involving physician from the very first step in enrollment, Pluri anticipates much needed physician oversight in determining the integrity of imported data, clinical data of interest for the patient and for potential researchers, and utilizing Pluri in good faith, with purpose of bettering one's own health state. These are improvements to prior art which is often adversely affected by dissemination of false information, lack of physician oversight, and malicious intentions by few patients or marketers.

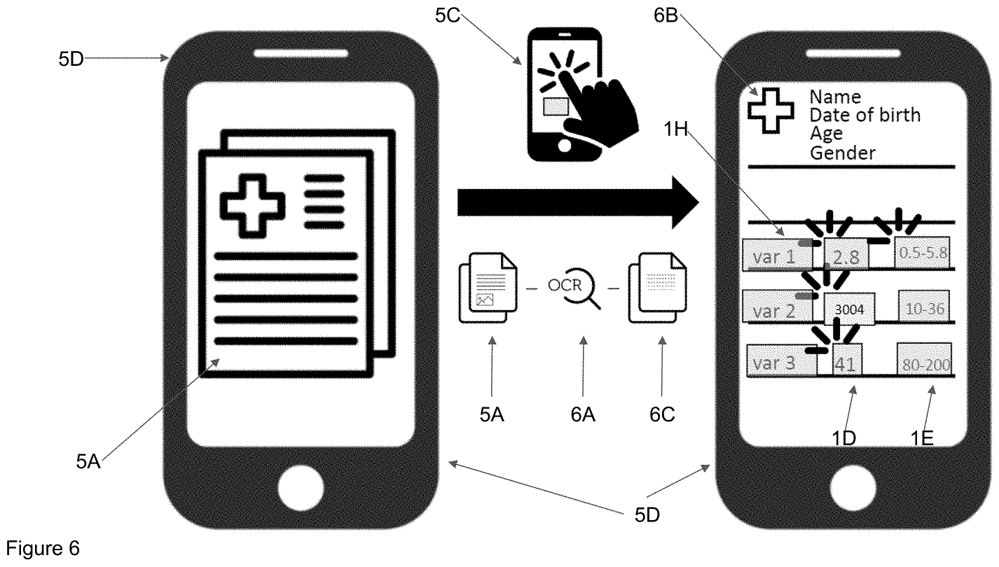

From the patient's personal device 5D, the next step (as shown in FIG. 6) is the post-processing (step 5C) of the medical laboratory value document 5A. Step 5C involves the original document 5A undergoing OCR (optical character recognition) process 6A, which then results in a post-processed data set (6C). Included in the step (5C) are the patient's decision making process which determines and designates which laboratory values will be officially imported and shared to Pluri with input from the patient. An example of 6C is shown, which would consist of general patient information, along with the patient's laboratory variables 1H, the corresponding values 1D of the laboratory variables, and their respective reference ranges 1E. These importations are confirmed as accurate by the patient and/or physician through 5C, and the end result of OCR-based importation 6A, along with patient-driven post-processing step 5C, is 6B. The patient-physician pair will verify that (1) the importing process did not alter the original data, (2) the pair will publish only the relevant parts of one's medical record, and (3) avoid omission or nondisclosure of key components of one's health state. Information publishing within Pluri is both targeted and guided as they result from patient-physician pair's shared-decision making.

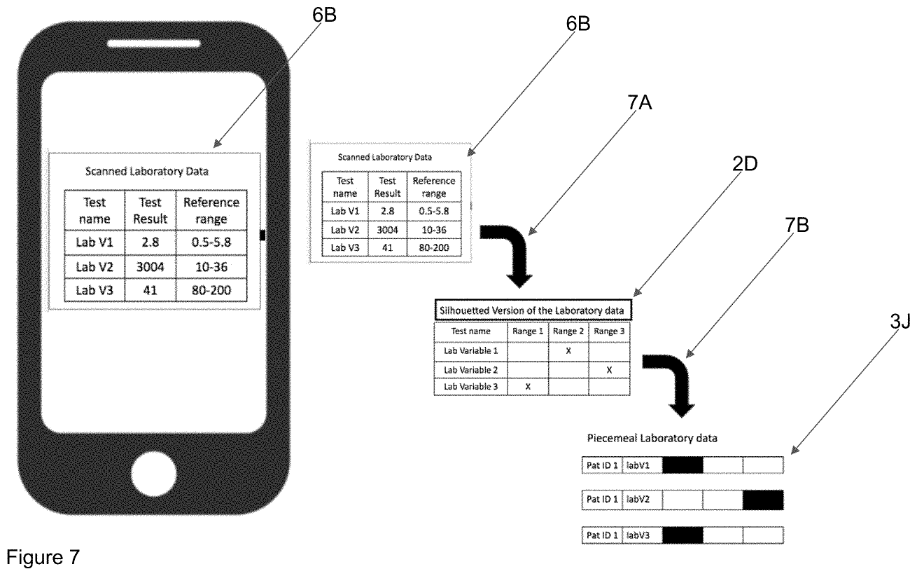

FIG. 7 shows an overview of the internal data processing steps taken to silhouette, binarize, and mask the data for an individual person. The end result of the importation 6B is converted into silhouetted ranges 2D (step 7A). Subsequently, the binarized values 3J are generated from the range values 2D (step 7B).

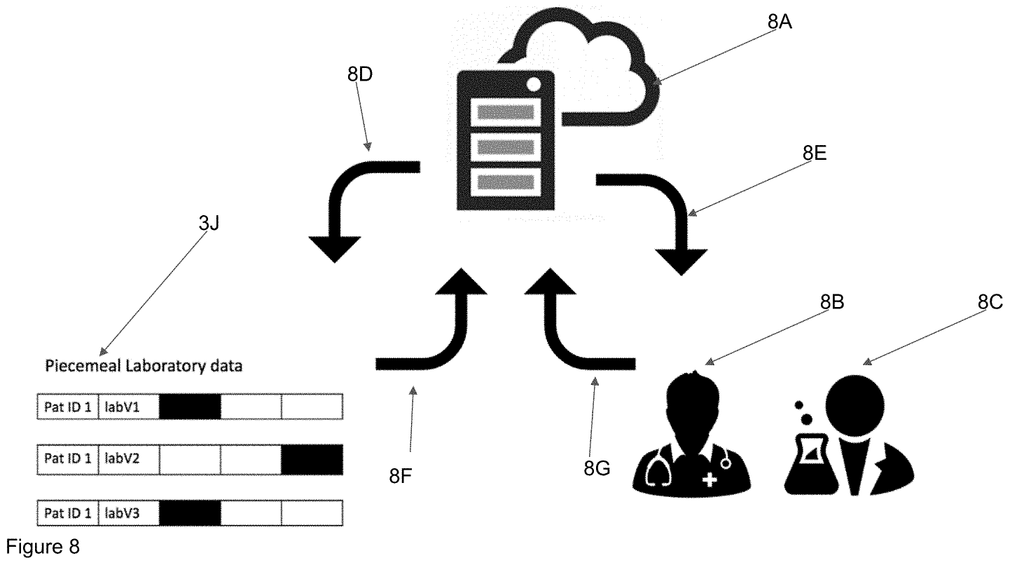

In FIG. 8, we demonstrate four major entities involved in Pluri, the software-based platform proposed in this application. 3J represents the set of data of patients who are on the Pluri platform where they seek to be matched with other parties of similar interest. In order to do so, they make their data available to Pluri's cloud infrastructure (8A) by publishing (8F) their post-processed data. Physician subject matter experts (SMEs), or specialists (8B) and research scientists, or clinical investigators (8C) can utilize the system by submitting a query (8G) to seek relevant datasets of interest or in need for expanding their scientific endeavors. If the query results in a match, the relevant dataset is made available (8E) to 8B or 8C. Initial match would only return masked, or binarized data (3A, 3B, 3C, or 3J) in piecemeal as pre-determined by the patients. If 8B or 8C seek to obtain further data, which may include patient demographics, comorbid conditions, or absolute value of such laboratory data of interest, they are able to seek further communication with the patient via process 8D. Upon receiving 8D, the patient may elect to provide further details and data, by uploading such to Pluri system via process 8F as previously discussed. Through process 8D, 8E, 8F, 8G, Pluri is able to facilitate patient-to-researcher communication, data-acquisition, patient-initiated personal data dissemination to the research arena, and much broader and easier scientific inquiries and hypothesis testing, between the parties who have never made in-person contact outside of the Pluri platform 8A. This improves upon prior art where access to patient data is typically limited to those obtained from patients that subject matter expert physicians or researchers have seen and evaluated in person from previous clinical encounters. With Pluri, the people utilizing healthcare data beyond personal patient use are able to benefit from amassing larger quantities of data from various sources, whom they otherwise would not have met or have had access to based on current practice.

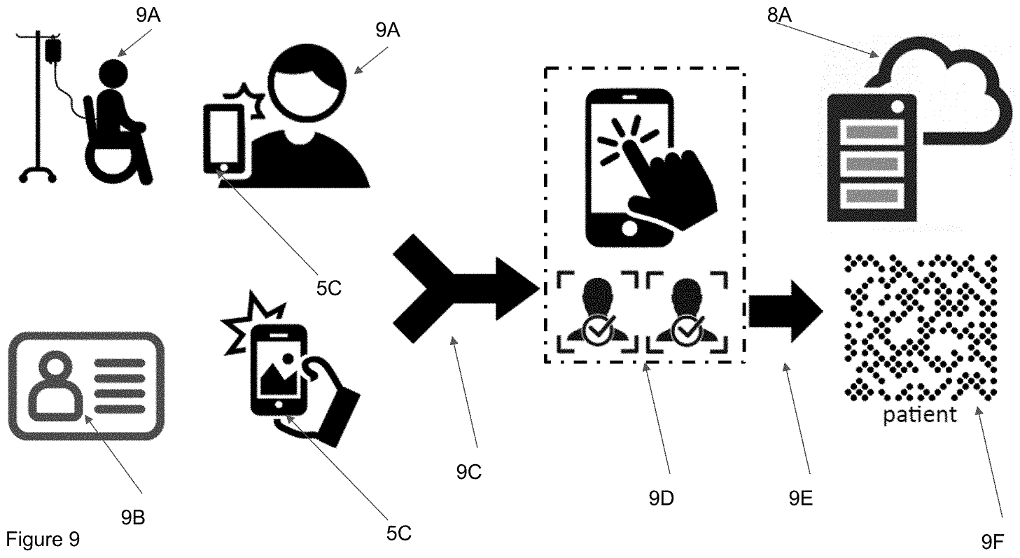

FIG. 9 is an overview of the initial enrollment process that a patient is expected to undertake when signing up for an account on the Pluri platform. The patient (9A) would utilize one's own device (5C) to obtain a photo of their face (9A); additionally, the patient's government-issued photo ID (9B) is imported to Pluri's proprietary software app installed on 5C. Through the process 9C, the patient's photo from the ID and one's self-obtained face photo are merged, verified through process (9D), which then through process of encryption (9E), is turned into a unique token (QR code identifier (9F) in the current embodiment) to be utilized within the Pluri platform (8A).

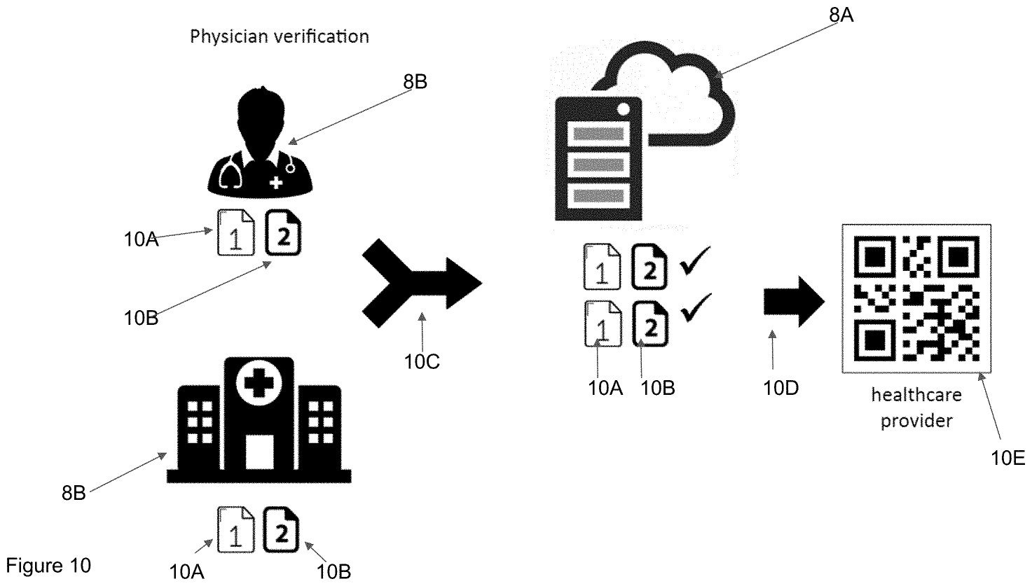

FIG. 10 is an overview of the initial enrollment process that a subject matter expert, specialist, or clinical researcher (8B) is expected to undertake when signing up for Pluri for the first time. 8B provides 2 forms of unique identifying information (10A, 10B) (for example: date of employment, unique tax ID provided by the employer, date of birth (DOB), employee ID number, etc.). These will be verified, merged, against those corresponding values (10A, 10B) independently provided by the 3rd party, oftentimes their employer (8B) through the process of 10C. Once the person's identity is verified via Pluri's program (8A), a unique identifier QR code (10E) is generated through the encryption process (10D), which will be used to represent their identity within the Pluri system.

Pluri implements a simple but powerful enrollment verification process to minimize publication of false data, false identity, and potentially malicious acts by those enrolling on the platform. State-of-the-art approaches of personal identification (for example use of facial recognition and matching process, coupled with government-issued ID) will be used for this purpose. An added layer of security is implemented as a physician partner is verified as described in FIG. 10, who then personally verifies the identity of a patient in real-life.

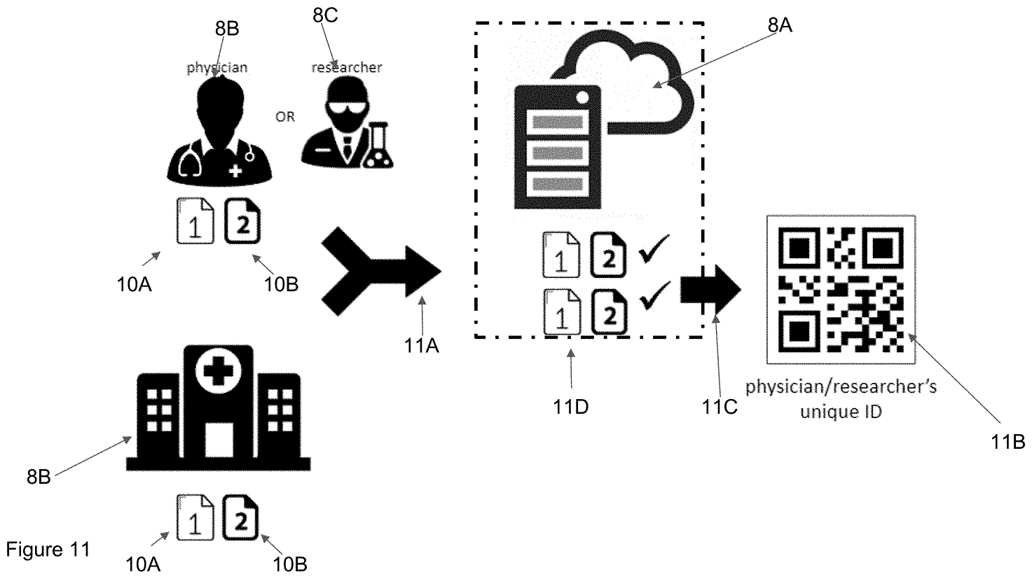

FIG. 11 is an overview of the initial enrollment process that clinical researchers (8C) are expected to undertake when signing up for Pluri for the first time. 8C provides 2 forms of unique identifying information (10A, 10B) (for example, date of employment, unique tax ID provided by the employer, DOB, employee ID number), which will be verified, merged, against those corresponding values (10A, 10B) independently provided by the 3rd party, oftentimes their employer (8B) through the process of 11A. Once one's identification is verified via Pluri's program (8A), through the encryption process (11D and 11C), a unique identifier QR code (1B) is generated, which will be used to represent one's identity as a clinical trial researcher within 1024

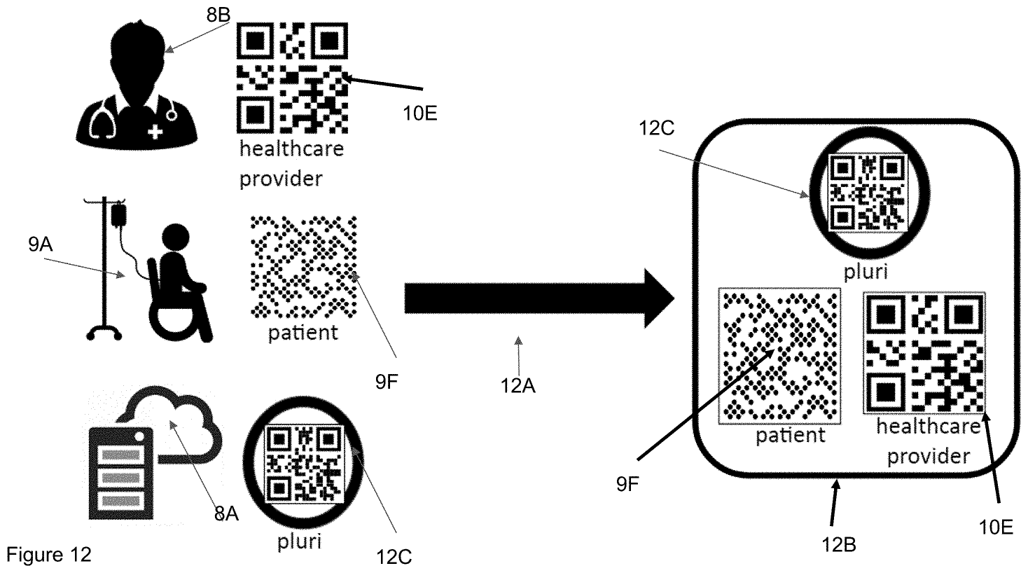

FIG. 12 is an overview of how the Pluri system will recognize unique identifiers and their pairings (interactions) as sets of unique security tokens (QR codes in the current embodiment). Unique tokens 10E, 9F, 12C are issued for each respective party, such as physician specialist (8B), patient (9A), and a partition of Pluri (8A) within which such interactions take place. These identifiers are summed in step 12A, which results in a unique identifier 12B consisting of the sum of unique identifiers of members involved within that interaction/conversation. This allows Pluri to quickly and securely re-establish pre-existing conversation and interactions between multiple parties, without needing to undergo re-verification process, or re-identification of non-patient members within the system (whose identity are not hidden, but may become difficult to locate due to plurality of such experts within the system). This identifier approach is also beneficial for the patient, who, once they have been registered on the platform as described in FIG. 11, remains anonymous for the entirety of their time on Pluri. Information stored with regards to their existing contacts and interaction with physician specialists or researchers allow the latter 2 groups to quickly and securely re-establish communication with their patients over time and at different points throughout the interactions. In another instantiation, such a connection can be used to enable physician specialists or researchers to track back to high fidelity data, if desired or required.

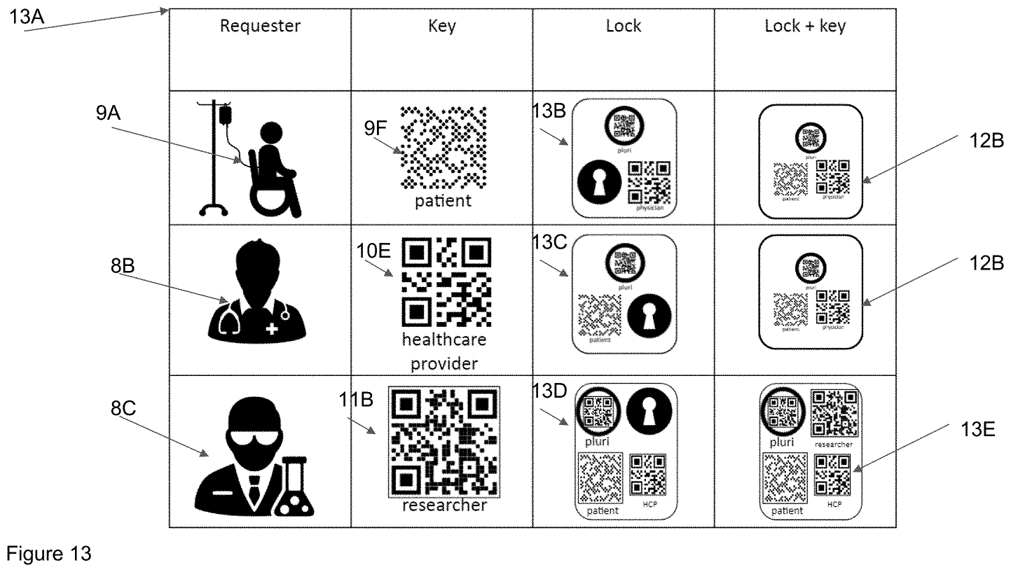

FIG. 13 shows aggregate overview (13A) of unique identifiers and their interplay that enhances continued and secure communication between already-established parties, and secure transaction of ideas and private health information. As previously demonstrated, Pluri securely stores connections made between each party involved. As a result, once the connections involving 1 or more parties are generated, a unique set of token aggregates (12B) are generated (QR codes in this embodiment) and stored within the system, allowing quick re-establishment of connections between the parties who have previously engaged with one another in the past. Such connection can only be reestablished if the user's unique identifying token (QR code) is matched to the incomplete QR code aggregates (13B, 13C, 13D) resulting in previously established QR code aggregates with valid check-sum (12B, 13E). This allows patients to remain anonymous without ever needing to store personally identifiable data on the Pluri system.

Auction:

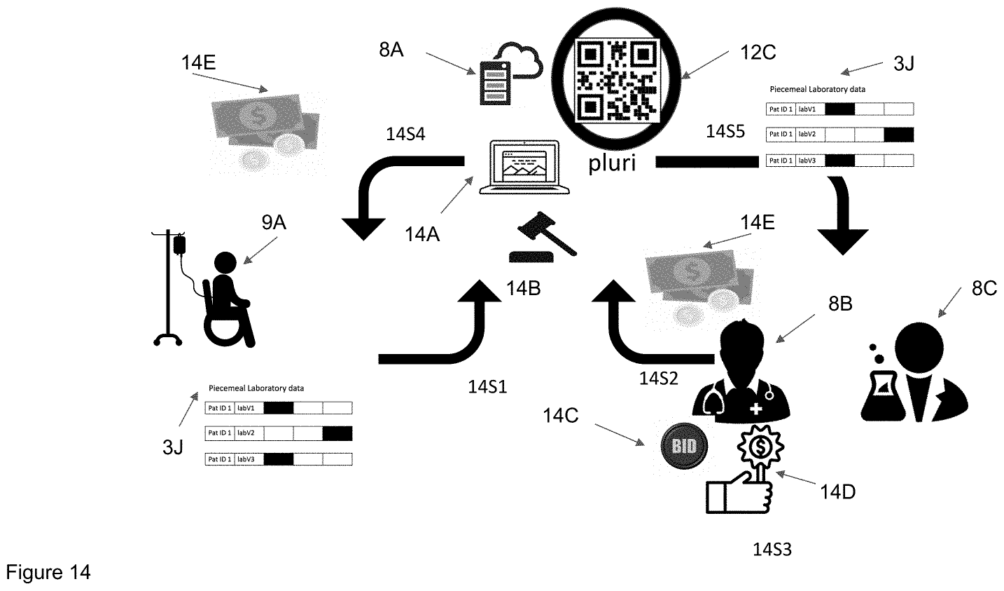

FIG. 14 details how patients can auction access to their data. The patient 9A decides which data 3J will be made available for Pluri 12C. Those patient-permitted data will be made searchable by physicians 8B, researchers 8C, or clinical trial investigators 8B-8C. In one auction instantiation 14A-14B, the patient can sell complete rights to their data at a fixed price to the winning bid 14D. The steps involved in the auction process are outlined as:
Step 14S1: the patient 9A decides which data 3J to upload to the Pluri portal 14A.
Step 14S2: the physician 8B, researcher 8C, or clinical trial investigator 8B-8C, submits bids for that data.
Step 14S3: the highest bid 14D is selected as the winner.
Step 14S4: the funds 14E are transferred to the patient 9A
Step 14S5: Pluri provides access to the data to the auction winner (8B in this embodiment).

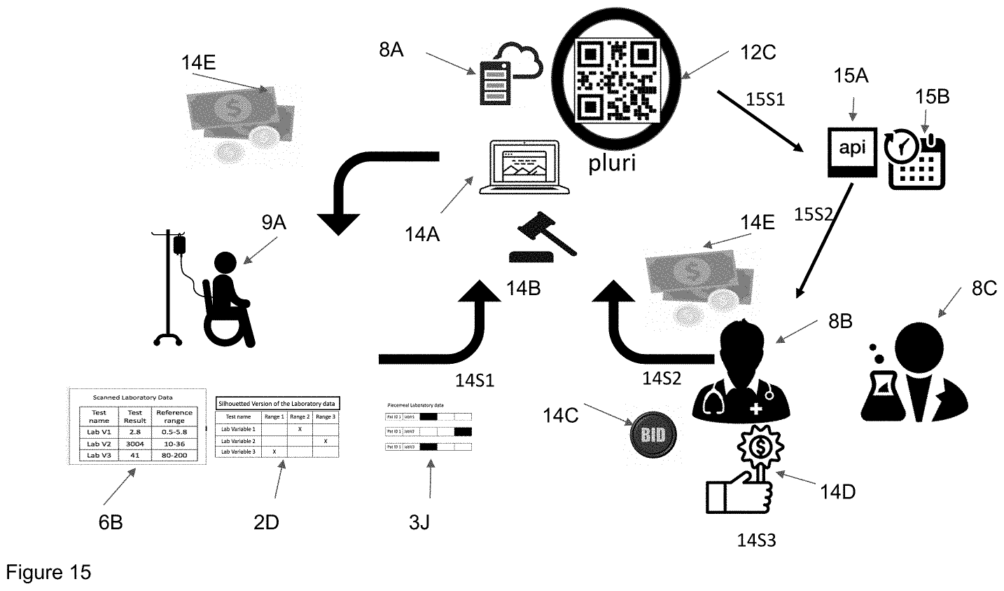

The patient can also decide which portions of their data (as suggested by embodiments of 6B, 2D, or 3J) will be made available for Pluri 12C, as shown in FIG. 15. Those patient-permitted data will be made searchable by physicians 8B, researchers 8C, or clinical trial investigators (8B-8C). In one auction instantiation 14A-14B, the patient 9A can sell time-bound (15B) API-access (15A) to winning bid 14D to their data—such access could be to different detail-levels of the data (as suggested by embodiments of 6B, 2D, or 3J) and different intervals of time, as determined by the patient. Access to the API 15A expires at the end of the time-bounding period 15B.

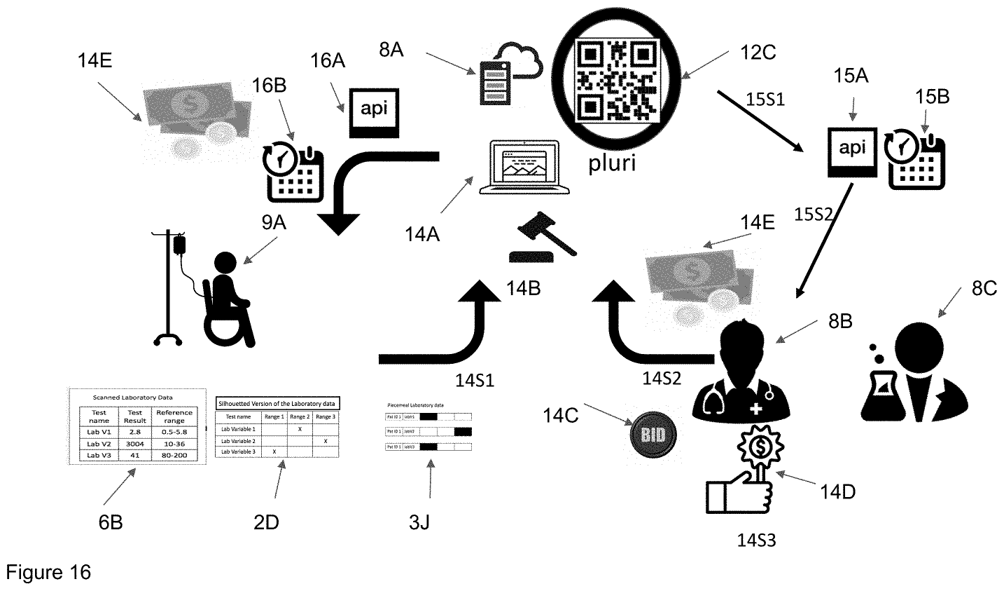

In another embodiment, shown in FIG. 16, a patient-facing API 16A is also open for a finite time 16B (controlled by the patient) allowing patient-controlled access to the data on the patient's smartphone or local device. In one embodiment, such an API can be used by the patients to allow access to high-resolution, unsilhouetted data on their smartphone or local device; this can potentially be provided as a separate data category in the auction by the patient. In this embodiment, the high-resolution, unsilhouetted data is pulled on the Pluri platform by the patient-facing API 16A, anonymized, and then either pushed out to/pulled by the winner bid 14D, via the 15A API. The 16A and 15A APIs expire after the finite time 16B and 15B have respectively lapsed.

Identification in the Auction:

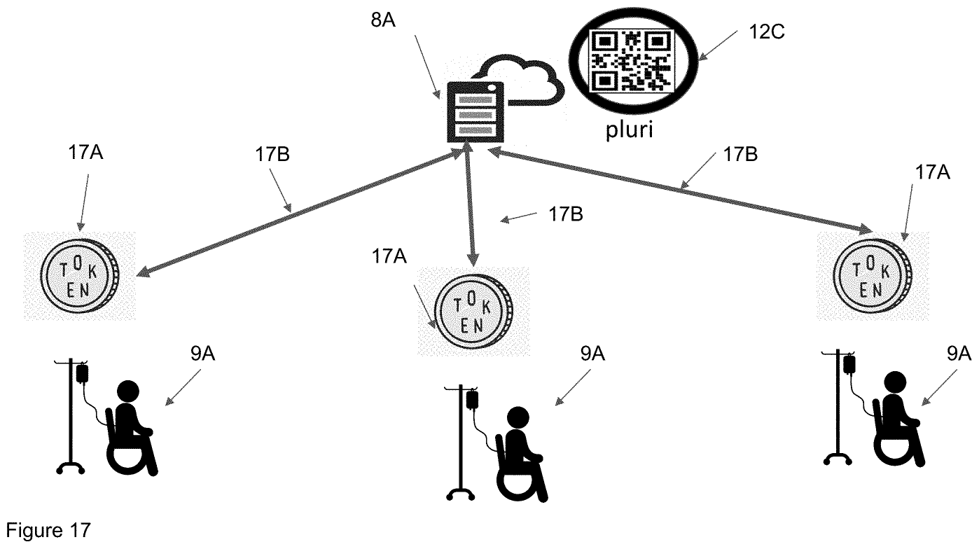

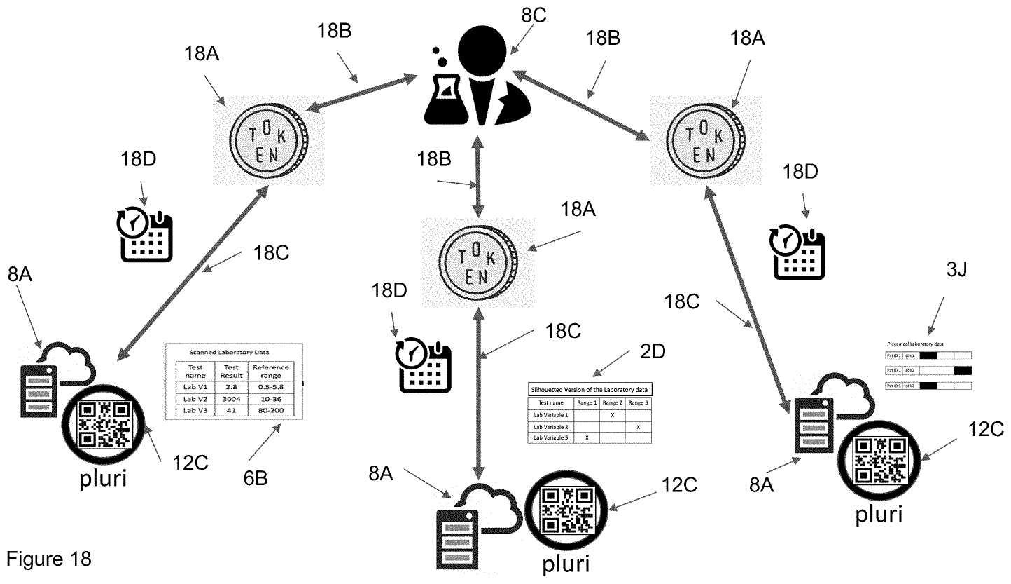

As shown in FIG. 17, each patient 9A can have a unique token identifier 17A tying them to the Pluri platform 12C, and housed in Pluri's cloud infrastructure 8A. Physicians 8B, researchers 8C, or clinical trial investigators (8B-8C) wanting to get access to datasets can have multiple tokens 18A, with each token giving them time-limited (18D) access to a fixed dataset (6B, 2D, 3J in one embodiment), as shown in FIG. 18. The tokens expire based on the terms of the auction; and will be tied to the Pluri platform 12C and housed in Pluri's cloud infrastructure 8A.

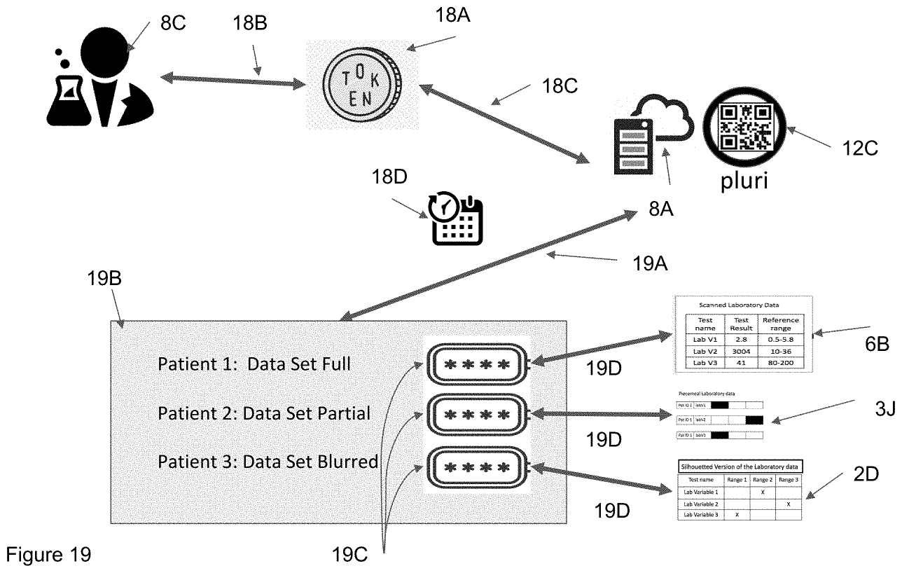

In another embodiment, shown in FIG. 19, physicians 8B, researchers 8C, or clinical trial investigators (8B-8C) wanting to get access to datasets can have multiple tokens 18A with each token giving them time-limited 18D access to a fixed dataset (6B, 2D, 3J in one embodiment). The researcher's unique token 11B (which uniquely help identify the researcher) is tied to collection of tokens 18A (which are unique entities representing a researcher's time-bound access rights to patient data) on the Pluri platform 12C housed in Pluri's cloud infrastructure 8A; these tokens are building up the dataset by bundling multiple patients data 19C, as shown in FIG. 19. The tokens expire 18D based on the terms of the auction; and will be housed in Pluri, and are connected 19A to patient datasets 19B-19C-19D.

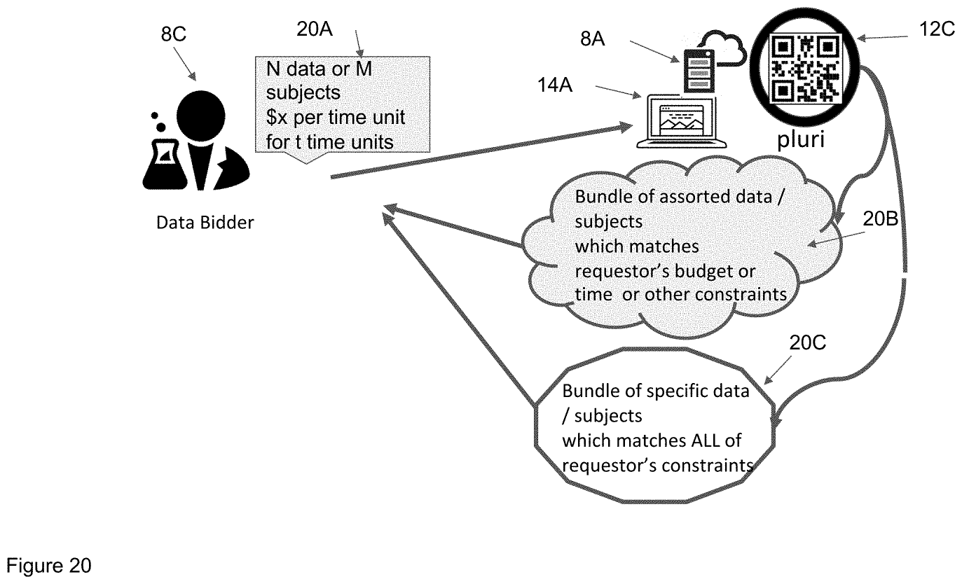

In one embodiment, as shown in FIG. 20, physicians 8B, researchers 8C, or clinical trial investigators (8B-8C) can search/ask as in 20A for a specific type/quantity N of data or specific number of subjects M, and indicate they are willing to pay $x per time unit for t time units (e.g. $x per day for 30 days access), through the Pluri auction portal 14A. In one instance of this embodiment, 20B, they can be offered a choice that bundles an assortment of data and/or subjects which matches one or multiple of their inquiry terms, but not all of their inquiry terms. Another instance of this embodiment, 20C, matches all their criteria/constraints for the data. Another instance of this embodiment allows varying pricing options for varying degrees of accuracy in the data provided. Another instance of this embodiment would suggest potential price ranges for the patient's data based on auction trends seen on the platform and in the marketplace.

### CONCLUSION

Identifiers, such as “(a).” “(b),” “(i),” “(ii), etc., are sometimes used for different elements or steps. These identifiers are used for clarity and do not necessarily designate an order for the elements or steps.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, with out departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer system linked to a cloud module, with data analysis, processing, and communication system, that allows biological owner of health data (also known as “data-owners”) to use various data-owner-initiated permissions to control access to that data by third parties (also known as “data-utilizers”), comprising of
enabling a data-owner to collect their health data and control the level of access to their health data by data-utilizers through the use of data encryption and data blurring to be within certain data ranges;
enabling an auction approach for paid time-limited, or data-blurring-limited, or both time- and data-blurring-limited access to the data-owner's data based on predefined criteria by the data-owner.

2. The system of claim 1, which may be a cloud system, wherein the data-owner's medical data is encrypted through the electronic system.

3. The system of claim 1, which may be an electronic system, wherein the data-owner's data is stored by the data-owner on their personal device such as smartphone, or smart device.

4. The electronic system of claim 2, wherein the data-owner's encrypted medical data is stored by the data-owner in their personal storage system, which could be cloud-based.

5. The electronic system of claim 2 where the data-owner collects their medical data through data-owner-initiated physical-to-digital importing by various digital solutions available in the marketplace.

6. The electronic system of claim 2 where the data-owner imports their data through data-owner-initiated digital-to-digital importing by various digital solutions available in the marketplace.

7. The cloud system of claim 2, wherein the data-owner's data is configured to meet individual data-owner's personal and privacy preferences.

8. The cloud system of claim 7, wherein the data-owner's data is published online in a data-utilizer-facing view as a function of the data-owner's personal and privacy preferences.

9. The cloud system of claim 7, wherein the data-owner is provided the ability to control the blurring of data that will be displayed to, or shared with, data-utilizers.

10. The cloud system of claim 9, where the data blurring may consist of defining general resolution ranges within which the exact values of the data exist.

11. The cloud system of claim 9, wherein the data-owner is provided the ability to control the blurring of more than one data variable that will be displayed to or shared with the data-utilizers.

12. The cloud system of claim 1, wherein the data analysis module is configured to assist the data-utilizers in the analysis of data of both the single data-owner and multiple data-owners.

13. The electronic system of claim 1 where the data owner-provided data can be medical and health-related.

14. The electronic system of claim 2 where the data owner-identity is confirmed by verification from their health care provider.

15. The electronic system of claim 2 where the data-owner's medical data is obtained by the data-owner in coordination with the health care provider.

16. The electronic system of claim 2 where the authenticity of the data-owner's medical data is confirmed by verification of the health-care provider providing the data.

17. The cloud system of claim 1 wherein data-owner-confirmed data is analyzed to enable case studies or disease-specific population studies without confines and boundaries of a hospital system.

18. The cloud system of claim 17 where the data-owner data and cases are amassed without seeing the data-owner in person.

19. The cloud system of claim 17 where the data-owner data and cases are amassed without having a direct formal referral that allows to connect them on an 1-on-1 data-owner-to-physician basis.

20. The cloud system of claim 17 is configured to “assist” in screening the data-owner's data for use by data-utilizer (e.g. sorting, inclusion, and/or exclusion for data-utilizer relevant data).

21. The cloud system of claim 17 where a provenance (trace-back) function is provided to allow a data-utilizer to request further communication with the original owner of the particular data.

22. The electronic system of claim 17, which, based on key features of data-owner's data, suggests, to data-utilizers, particular groups of people (e.g. disease groups, data-owner organizations, etc.) with known associations to such key features.

23. The cloud system of claim 22 where the data-owner data and cases are amassed without seeing the data-owner in person.

24. The cloud system of claim 22 where the data-owner data and cases are amassed without having a direct formal referral that allows to connect them on an 1-on-1 data-owner-to-physician basis.

25. The cloud system of claim 22 is configured to “assist” in screening the data-owner's data for use by data-utilizer (e.g. sorting, inclusion, and/or exclusion for data-utilizer relevant data).

26. The cloud system of claim 22 where a provenance (trace-back) function is provided to allow a data-utilizer to request further communication with the original owner of the particular data.

27. The cloud system of claim 1 wherein a researcher or a clinical trial investigator can amass large numbers of data-owner cases and data to search for laboratory values of interest.

28. The cloud system of claim 27 where the data-owner data and cases are amassed without seeing the data-owners in person.

29. The cloud system of claim 27 where the data-owner data and cases are amassed without having a direct formal referral that allows to connect them on an 1-on-1 data-owner-to-physician basis.

30. The cloud system of claim 27 is configured to “assist” in screening the data-owner's data for use by data-utilizer (e.g. sorting, inclusion, and/or exclusion for data-utilizer relevant data).

31. The cloud system of claim 27 where a provenance (trace-back) function is provided to allow data-utilizers to request further communication with the original owner of the particular data.

32. The electronic system of claim 27, which, based on key features of data-owner's data, suggests, to data-utilizers, particular groups of people (e.g. disease groups, data-owner organizations, etc.) with known associations to such key features.

33. The cloud system of claim 32 where the data-owners data and cases are amassed without seeing the data-owners in person.

34. The cloud system of claim 32 where the data-owners data and cases are amassed without having a direct formal referral that allows to connect them on an 1-on-1 data-owner-to-physician basis.

35. The cloud system of claim 32 is configured to “assist” in screening the data-owners' data for use by data-utilizer (e.g. sorting, inclusion, and/or exclusion for data-utilizer relevant data).

36. The cloud system of claim 32 where a provenance (trace-back) function is provided to allow a data-utilizer to request further communication with the original owners of the particular data.

37. The cloud system of claim 1 in which, once data-owner's data is imported onto the system, the data-utilizers are able to incorporate multiple data points from that data-owner that may have been amassed from various health systems, and electronic health and medical records of different formats.

38. The cloud system of claim 37 where the data-owner data and cases are amassed without seeing the data-owner in person.

39. The cloud system of claim 37 where the data-owner data and cases are amassed without having a direct formal referral that allows to connect them on an 1-on-1 data-owner-to-physician basis.

40. The cloud system of claim 37 is configured to “assist” in screening the data-owner's data for use by data-utilizer (e.g. sorting, inclusion, and/or exclusion for data-utilizer relevant data).

41. The cloud system of claim 37 where a provenance (trace-back) function is provided to allow a data-utilizer to request further communication with the original owner of the particular data.

42. The cloud system of claim 1 in which, once multiple data-owners data are imported onto the system, the data-utilizers are able to incorporate multiple data points from the multiple (or a subset of) data-owners that may have been amassed from various health systems, and electronic health and medical records of different formats.

43. The cloud system of claim 42 where the data-owners data and cases are amassed without seeing the data-owners in person.

44. The cloud system of claim 42 where the data-owners data and cases are amassed without having a direct formal referral that allows to connect them on an 1-on-1 data-owner-to-physician basis.

45. The cloud system of claim 42 is configured to “assist” in screening the data-owner's data for use by data-utilizer (e.g. sorting, inclusion, and/or exclusion for data-utilizer relevant data).

46. The cloud system of claim 42 where a provenance (trace-back) function is provided to allow a data-utilizer to request further communication with the original owners of the particular data.

47. The cloud system of claim 2 in which each data-owner's data can be grouped into categories based upon interest of the data-utilizer (such as degree of abnormality, change in values over time, and demographics including age, gender, time of diagnosis, previous therapeutic interventions, etc).

48. The cloud system of claim 47 is configured to “assist” in screening the data-owner's data for use by data-utilizer (e.g. sorting, inclusion, and/or exclusion for data-utilizer relevant data).

49. The cloud system of claim 47 where a provenance (trace-back) function is provided to allow a data-utilizer to request further communication with the original owner of the particular data.

50. The electronic system of claim 7 where the data-owner may designate a monetary value which incurs when the said data is accessed (or requested to grant access) by a data-utilizer.

51. The electronic system of claim 50 where the monetary value designated to medical data may have a minimum reserve price undisclosed to the requesting data-utilizer (bidders).

52. The electronic system of claim 50 where the minimum reserve price for the monetary value can be established either by the data-owner individually, by the community, or by the platform.

53. The electronic system of claim 50 where monetary transactions are performed with a commission or transaction fee applied.

54. The electronic system of claim 50 where the time duration of access to the medical data can be established by the data-owner individually, by the community, or by the platform.

55. The electronic system of claim 50 where the data-owner may designate the monetary compensation to be deposited to oneself, or to data-owner-centered organizations of one's choice, or donate to the electronic system.

56. The electronic system of claim 50 when aiding the data-owner in determination of monetary value, may display a suggested price of the said data, based on recent transaction history within the electronic system of a similar clinical category or characteristics.

57. The electronic system of claim 50 where the monetary transaction portion of the system can remain inactive for the initial review by the data-utilizer of the data-owner's data.

58. The electronic system of claim 50 where the monetary transaction portion of the system may activate once the data utilizer requests a direct contact with the data-owner, or inquires for additional data from the data-owner.

59. The electronic system of claim 50 in which the use of any feature that involves value-assignment (e.g whether to activate or not activate monetary transactions on their data) to the data-owner's data is decided by the data-owner him/herself.

60. The electronic system of claim 50 in which the data-owner may elect to publish data free of charge.

61. The electronic system of claim 8 where the data-owner may designate a monetary value which incurs when the said data is accessed (or requested to grant access) by a data-utilizer.

62. The electronic system of claim 61 where the monetary value designated to medical data may have a minimum reserve price undisclosed to the requesting data-utilizer (bidders).

63. The electronic system of claim 61 where the minimum reserve price for the monetary value can be established either by the data-owner individually, by the community, or by the platform.

64. The electronic system of claim 61 where monetary transactions are performed with a commission or transaction fee applied.

65. The electronic system of claim 61 where the data-owner may designate the monetary compensation to be deposited to oneself, or to data-owner-centered organizations of one's choice, or donate to the electronic system.

66. The electronic system of claim 61 when aiding the data-owner in determination of monetary value, may display a suggested price of the said data, based on recent transaction history within the electronic system of a similar clinical category or characteristics.

67. The electronic system of claim 61 where the monetary transaction portion of the system can remain inactive for the initial review by the data-utilizer of the data-owner's data.

68. The electronic system of claim 61 where the monetary transaction portion of the system may activate once the data utilizer requests a direct contact with the data-owner, or inquires for additional data from the data-owner.

69. The electronic system of claim 61 in which the use of any feature that involves value-assignment (e.g whether to activate or not activate monetary transactions on their data) to the data-owner's data is decided by the data-owner him/herself.

70. The electronic system of claim 61 in which the data-owner may elect to publish data free of charge.
